(19) United States
(12) Patent Application Publication
(10) Pub. No.: US 2006/0024035 A1
(43) Pub. Date: Feb. 2, 2006

(54) Control system of transfering pulse width moldulation for a cooling fan motor

(76) Inventor: He-Wen Lin, Taipei (TW)

Correspondence Address: G. LINK Co., LTD.;Suite 137, 931 West 75th Street, PMB 174, Naperville, IL, 60565, US

(21) Appl. No.: 10/900,233

(22) Filed: Jul. 28, 2004

(30) Foreign Application Priority Data
Jul. 28, 2004 (TW) 92120500

(51) Int. Cl. H02P 5/06

(52) U.S. Cl. 388/806

(57) ABSTRACT

A control system of transferring pulse width modulation for a cooling fan motor includes an input end of pulse width modulation, a transfer unit, a transfer unit and a drive circuit. The input end of pulse width modulation is for inputting pulse width modulation signal. The transfer unit is connected to the input end and transforms the pulse width modulation signal as analog voltage signals in different reference levels based on different duty cycles of the pulse with modulation signal. The drive circuit controls rotational speed of the fan motor based on the analog voltage signals in different levels.

### BACKGROUND OF THE INVENTION

1. Field of the Invention

The present invention is related to a control system of transferring pulse width modulation for a cooling fan motor and particularly to a control system, which can change the pulse width modulation signal into analog width modulation signals to control rotational speed of the fan motor.

2. Brief Description of the Related Art

The conventional way to control rotational speed of cooling fan motor is performed by way of the pulse width modulation signal controlling conducting time of the coil set in the fan motor to reach the purpose of controlling different rotational speeds based on different duty cycles. However, it is unfavorable that variables such as the amplitude, frequency and the duty cycle of the pulse width modulation signal can influence the rotational speed of the fan motor.

Further, referring to FIG. 1, the first type conventional circuit includes a reverse voltage protect diode 101, a Hall member 102, a drive member 103, a first transistor 104, a second transistor 105, a first resistor 106, a second resistor 107, a third resistor 108, a first motor coil set 109, a second motor coil set 120, a fourth resistor 121, a fifth resistor 122, a third transistor 123 and a fourth transistor 124. A drive circuit 10 consists of the Hall member 102, the drive member 103, the first transistor 104, the second transistor 105, the first resistor 106, the second resistor 107, the third resistor 108 and the first motor coil set 109 and the second motor coil set 120.

When the preceding circuit is powered on via the reverse voltage protect diode 101, the hall member 102 senses magnetic pole change of the rotor and generates positive voltage +H and negative voltage −H to output to the drive member 103. The preceding voltage can be transformed as control signal via the drive member 103 to output to the first transistor 104 and the second transistor 105 through a first output end OUT1 and a second output ends OUT2. A pulse width modulation input end PWM passes through the fourth resistor 121, the fifth resistor 122 and collectors of the third transistor 123 and the fourth transistor 124 such that the control signal source at the first output end OUT1 and at the second output end OUT2 of the drive member 103 is cut off to control the first motor coil set 109 and the second motor coil set 120, which are connected to the collectors of the first transistor 104 and the second transistor 105 respectively, and then to control rotational speed of the fan motor.

Referring to FIG. 2, the second type conventional circuit includes a reverse voltage protect diode 201, a Hall member 202, a drive member 203, a first transistor 204, a second transistor 205, a first resistor 206, a second resistor 207, a third resistor 208, a first motor coil set 209, a second motor coil set 220, a fourth resistor 221 and a third transistor 222. A drive circuit 20 consists of the Hall member 202, the drive member 203, the first transistor 204, the second transistor 205, the first resistor 206, the second resistor 207, the third resistor 208 and the first motor coil set 209 and the second motor coil set 220. A pulse width modulation input end PWM connects with a control input end ST of the drive member 203 via the fourth resistor 221 and the third transistor 222 and the drive circuit 20 is controlled to create switch actuation time by way of periodic change of pulse width modulation signal changing duty cycle of the pulse width modulation signal such that source power of the first motor coil set 218 and the second motor coil set 219 can be controlled and then rotational speed of the fan motor can be controlled too.

Referring to FIG. 3, the third type conventional circuit has a drive circuit 30, which consists of a reverse voltage protect diode 301, a Hall member 302, a drive member 303, a first transistor 304, a second transistor 305, a first resistor 306, a second resistor 307, a third resistor 308, a first motor coil set 309 and a second motor coil set 320. A pulse width modulation signal input end PMW controls ON and OFF of input power source via the fourth resistor 321 and the third transistor 322 to drive a first motor coil set 309 and a second motor coil set 320, which are connected to collectors of the first transistor 304 and the second transistor 305 respectively, and then rotational speed of the fan motor can be controlled too.

The preceding conventional ways with which the pulse width modulation signal is utilized to control the fan motor directly, have the following disadvantages:

1. An excessively large range of frequency changes of the pulse width modulation signal results in change rate of motor fan speed becomes increased and decreased suddenly along with the frequency changes.

2. The duty cycle of the pulse width modulation signal is constant and it is not easy to reach a desired fan motor rotational speed and range of speed change.

3. Electrical noise generates while the pulse width modulation signal provides excessive low frequency.

### SUMMARY OF THE INVENTION

A primary object of the present invention is to provide a control system of transferring pulse width modulation signal for a cooling fan motor with which a transfer unit generates analog voltage signals based on the duty cycle of the input pulse width modulation signal to control rotational speed of the fan motor.

Another object of the present invention is to provide a control system of transferring pulse width modulation signal for a cooling fan motor with which the transferred analog voltage signals are arranged with the resistance in the transfer unit to set high and low reference levels of the output analog voltage signals for adjusting high and low rotational speed of the fan motor.

A further object of the present invention is to provide a control system of transferring pulse width modulation signal for a cooling fan motor with which the transferred analog voltage signals are arranged with the resistance in the transfer unit to set change value of the analog voltage signals for increasing or decreasing control range of the pulse width modulation.

A further object of the present invention is to provide a control system of transferring pulse width modulation signal for a cooling fan motor with which the pulse width modulation signal can be transformed as analog voltage signals to reduce frequency change of the pulse width modulation signal so as to overcome deficiencies of rotational speed deviation of the fan motor and electrical noise generated from low frequency.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a circuit diagram of the first type conventional control system of transferring pulse modulation for a cooling fan;

FIG. 2 is a circuit diagram of the second type conventional control system of transferring pulse modulation for a cooling fan;

FIG. 3 is a circuit diagram of the third type conventional control system of transferring pulse modulation for a cooling fan;

FIG. 4 is a circuit diagram of a preferred embodiment according to the present invention;

FIG. 5a is a graph illustrating an input wave shape of pulse modulation signal according to the present invention;

FIG. 5b is a graph illustrating a wave shape of the pulse modulation signal after being transferred with an analog circuit according to the present invention;

FIG. 5c is a graph illustrating a wave shape of the transferred signal generating reference potentials of direct via a capacitor; and

FIG. 6 is a table of output voltages of different pulse width modulation signal being transferred as analog voltage signals via the analog circuit.

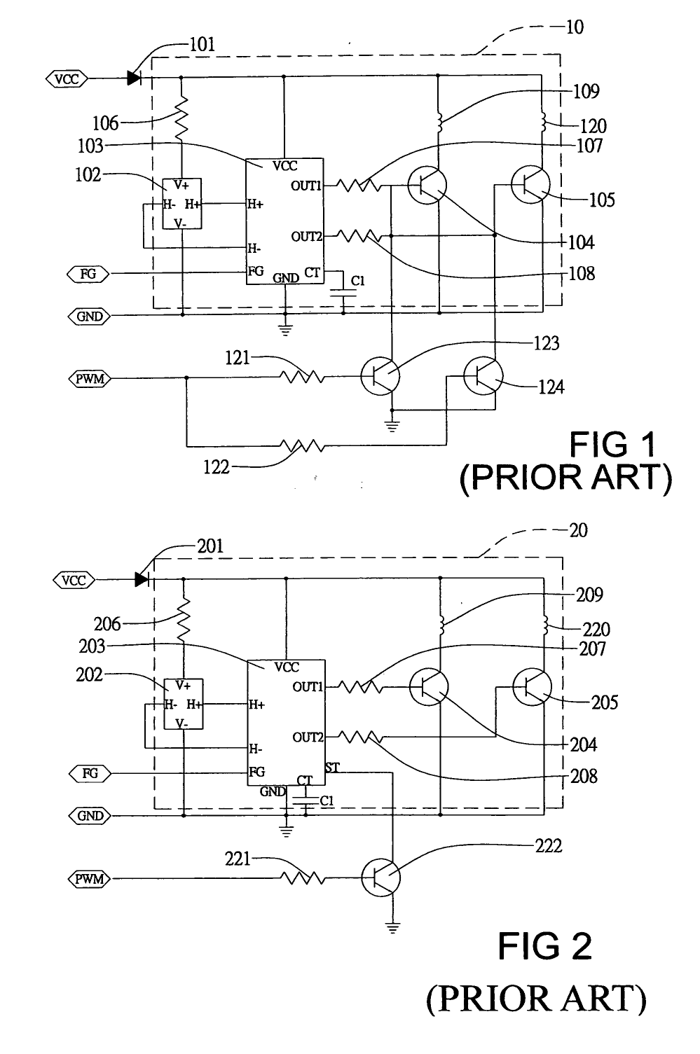

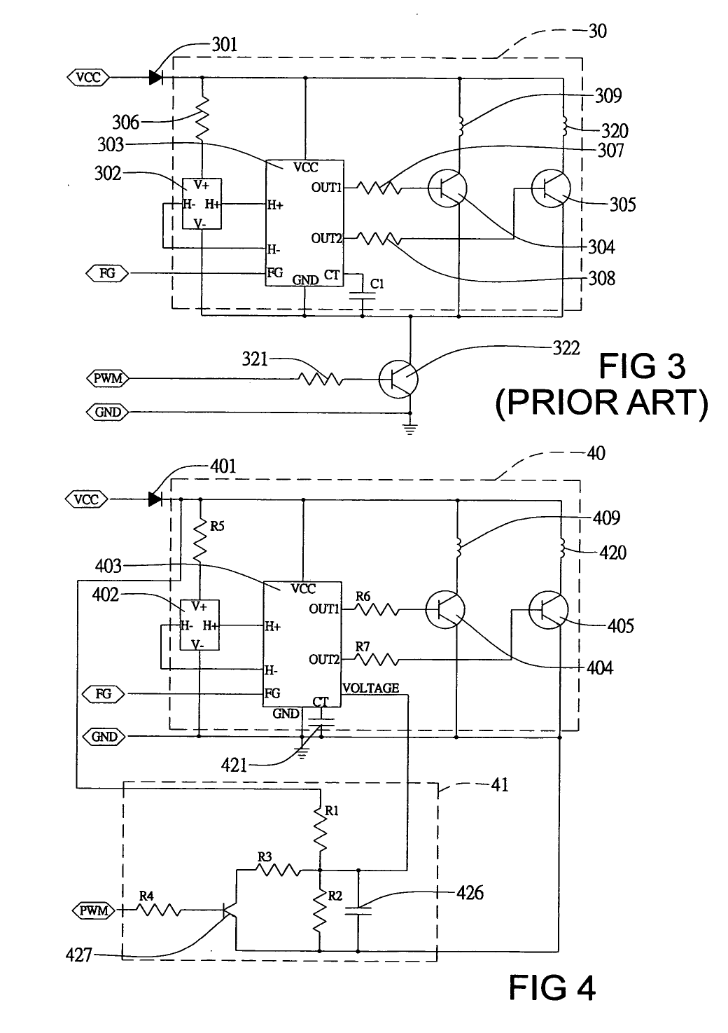

### DETAILED DESCRIPTION OF THE INVENTION

Referring to FIG. 4, a control system of transferring pulse width modulation for a cooling fan according to the present invention in the preferred embodiment thereof includes an reverse voltage protect diode 401, a Hall element 402, a drive member 403, a second transistor 404, a third transistor 405, a fifth resistor R5, a sixth resistor R5, a seventh resistor R7, a first motor coil set 409, a second motor coil set 420, a second capacitor 421, a fourth resistor R4, a third resistor R3, a first resistor R1, a second resistor R2, a first capacitor 426 and a first transistor 427. A drive circuit 40 in the control system consists of the Hall member 402, the drive member 403, the second transistor 404, the third transistor 405, the fifth resistor R5, the sixth resistor R6, the seventh resistor R7, the first motor coil set 409, the second motor coil set 420 and the second capacitor 421. Once the control system is powered on via the inverse pressure protection diode 401, the hall member 402 of the drive circuit 40 senses magnetic pole change of the rotor and generates positive voltage H+ and negative voltage H− to output to the drive member 403.

A pulse width modulation signal input end PWM is connected to a transfer unit and the transfer unit is an analog circuit 41, which consists of the fourth resistor R4, the third resistor R3, the first resistor R1, the second resistor R2, the first capacitor 426 and the first transistor 427. The pulse width modulation signal is transformed as analog voltage signals via the analog circuit 41 and the analog voltage signals are output to the drive member 403 so that the motor coil set 409 and the second motor coil set 420, which are connected to collectors of the second transistor 404 and the third transistor 405 respectively, can be driven and the rotational speed of the fan motor can be controlled.

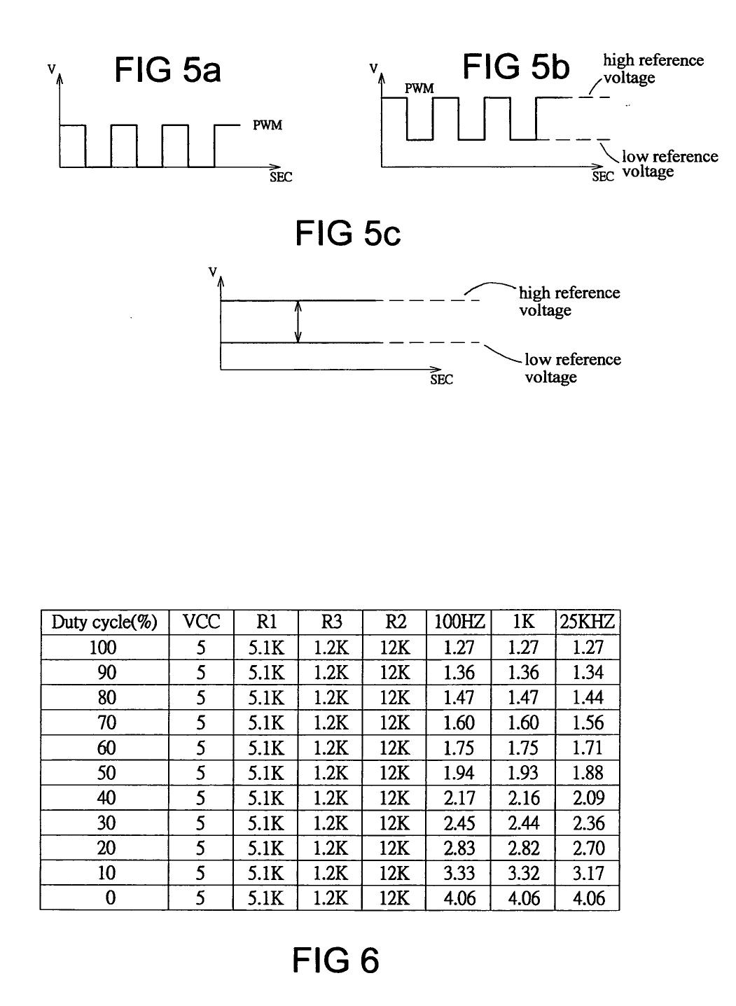

Referring to FIGS. 4. 5a, 5b and 5c, after passing through the analog circuit 41, the input pulse width modulation signal can be changed to analog voltage signals in different reference levels based on the duty cycle of the input pulse width modulation signal as shown in FIG. 5a. Further, the analog voltage signals can be arranged and set as high reference and the low reference voltages as shown in FIG. 5b via the third resistor R3, the first resistor R1, the second resistor R2 and then can form high and low direct reference voltages as shown in FIG. 5c after being filtered with the first capacitor 426. In this way, the high and low rotational speeds of the fan motor can be set and the variation of the analog voltage signal can be adjustably increased or decreased so that it can affect the control range of the input pulse width modulation signal.

Referring to FIG. 6 in company with FIG. 4, pulse width modulation signals in different frequencies are used to pass through the analog circuit 41 and the transformed output analog voltage signals are compared in the table shown in FIG. 6. It can be seen in the table that the input power is 5V and the analog circuit 41 provides the first resistor R1, the second resistor R2, the third resistor R3 with resistances 5.1kΩ, 12kΩ and 1.2kΩ respectively. When the pulse width modulation signals, which are in three different frequencies 25 KHZ, 1 KHZ and 100 KHZ, pass through the first resistor R1, the second resistor R2 and the third resistor R3, the output analog voltage signals in different duty cycles provide the high reference potential value and the low reference potential value are very close to each other. Hence, once the output analog voltage signals are used to control the rotational speed of the fan motor, the errors of the pulse width modulation signals result from frequency changes can be decreased greatly and phenomenon of deviating the fan motor rotational speeds can be decreases too.

It is appreciated that the control system of transferring pulse width modulation for a cooling fan according to the present invention has the following advantages:

1. Due to the output analog voltage signals being used to control the rotational speed of the fan motor, the errors of the pulse width modulation signals result from frequency changes can be decreased greatly and, accordingly, phenomenon of deviating the fan motor rotational speed can be diminished. That is, the pulse width modulation signals are much more affected by the duty cycles thereof during controlling the rotational speed of the fan motor.

2. The transformed analog voltage can be arranged by the first resistor R1, the second resistor R2 and the third resistor R3 of the analog circuit 41 so that the high and low reference levels of the analog voltage signals can be set and the highest and lowest rotational speeds of the fan motor can be set easily.

3. The transformed analog voltage signals can be arranged and set as high reference and low reference voltages after being arranged with the third resistor R3, the first resistor R1, the second resistor R2 so as to adjustably increase or decrease variation of the analog voltage signal. Hence, the control range of the input pulse width modulation signal can be increased or decreased.

4. The pulse width modulation signal being able to change to the analog voltage signal eliminates unfavorable variables having been long time in the pulse width modulation signal such as deviation of fan motor rotational speed resulting from frequency changes and electrical noise resulting from low frequency.

While the invention has been described with referencing to preferred embodiments thereof, it is to be understood that modifications or variations may be easily made without departing from the spirit of this invention, which is defined by the appended claims.

What is claimed is:

1. A control system of transferring pulse width modulation for a cooling fan motor, comprising:
an input end of pulse width modulation for inputting pulse width modulation signal;
a transfer unit, being connected to the input end and transforming the pulse width modulation signal as analog voltage signals in different reference levels based on different duty cycles of the pulse with modulation signal; and
a drive circuit, controlling rotational speed of the fan motor based on the analog voltage signals in different levels.

2. The control system of transferring pulse width modulation for a cooling fan motor as defined in claim 1, wherein the transfer unit is an analog circuit.

3. The control system of transferring pulse width modulation for a cooling fan motor as defined in claim 2, wherein the analog circuit comprises a first resistor, a first transistor, a second resistor, a third resistor, a fourth resistor and a first capacitor.

4. The control system of transferring pulse width modulation for a cooling fan motor as defined in claim 1, wherein the drive circuit comprises a hall member and a drive member.
